(19) United States
(12) Patent Application Publication
(10) Pub. No.: US 2004/0052610 A1
(43) Pub. Date: Mar. 18, 2004

(54) Dome headed roofing screw

(76) Inventor: David Kaupanger, Council, ID (US)

Correspondence Address: David Kaupanger, 2538 Council Cuprum Rd., Council, ID, 83612, US

(21) Appl. No.: 10/246,022

(22) Filed: Sep. 17, 2002

(51) Int. Cl. F16B 1/00

(52) U.S. Cl. 411/371.2; 411/403

(57) ABSTRACT

A dome headed design for a roofing screw intended to be used as a fastener for metal roofs. This new design for a roofing screw will improve its use. This fastener will lessen snow and ice damage to metal roofs in colder climates, and Produce less need to shovel snow and ice off of roofs.

### BACKGROUND

1. Field of Invention

This screw is designed to allow ice and snow to slide off of a metal roof with less resistance and less potential damage to the roofing material.

2. Description of Prior Art Roofing screws currently used to fasten down metal roofing have a hexagonal head.

An example of the screw head design in current use is demonstrated by U.S. Patent No. D419,431.

Another example is U.S. Pat. No. 4,516,893.

This design screw head used on a roofing screw poses two distinct disadvantages to the main purpose of metal roofing:

Notice that the hexagonal head design is raised above the roofing surface at a right angle. This right angle surface offers direct resistance to the natural sliding action of snow and ice downward and off of the roof. This results in, (a) a delay in the snow and ice load leaving the roof, (b) damage caused to the roofing material due to the screw being forced downward by the sliding snow and ice.

### OBJECTS AND ADVANTAGES

Use of my patent provides three objects and advantages to fastening down metal roofing, and listed below they are:

(a) to provide a screw head design on a roofing fastener that offers minimal resistance to the downward sliding action of snow and ice off of a roof, thereby speeding snow and/or ice removal from the roof,

(b) to provide a screw head design on a roofing screw that does not allow snow or ice to apply enough force against it to cause roofing damage.

(c) to provide less cause for home owners to shovel snow off of their roof.

### DRAWING FIGURES

FIG. 1 is a side elevational view of the roofing screw with the domed screw head.

FIG. 2 is a a top view of the screw head.

FIG. 3 is aside elevational view of the domed screw head.

FIG. 4 shows a projected interior of the domed screw head.

FIG. 5 is a side cross sectional view of the domed screw head including resilient washer.

FIG. 6 is a side cross sectional view of the domed screw head showing the positioning of the resilient washer between the bottom of the screw head and the roofing surface when fastener is in place.

FIG. 7 is a top, front perspective view of the roofing screw showing my new design of a dome headed roofing screw.

### REFERENCE NUMERALS IN DRAWINGS

1 screw head

2 square recessed slot for driving tool

3 indented seat for resilient washer

4 resilient washer

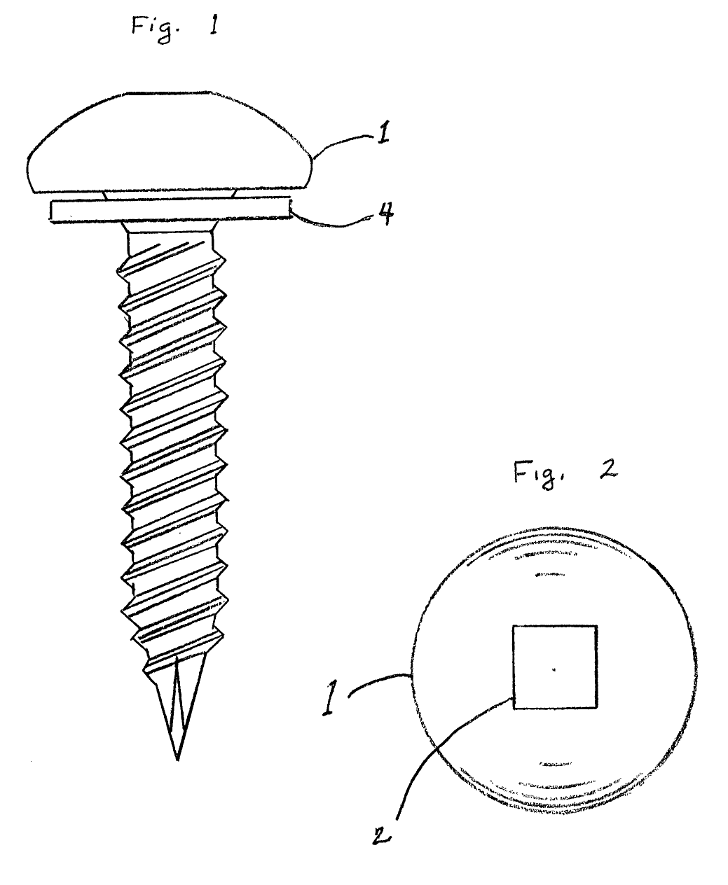

### DESCRIPTION—FIGS. 1 TO 7

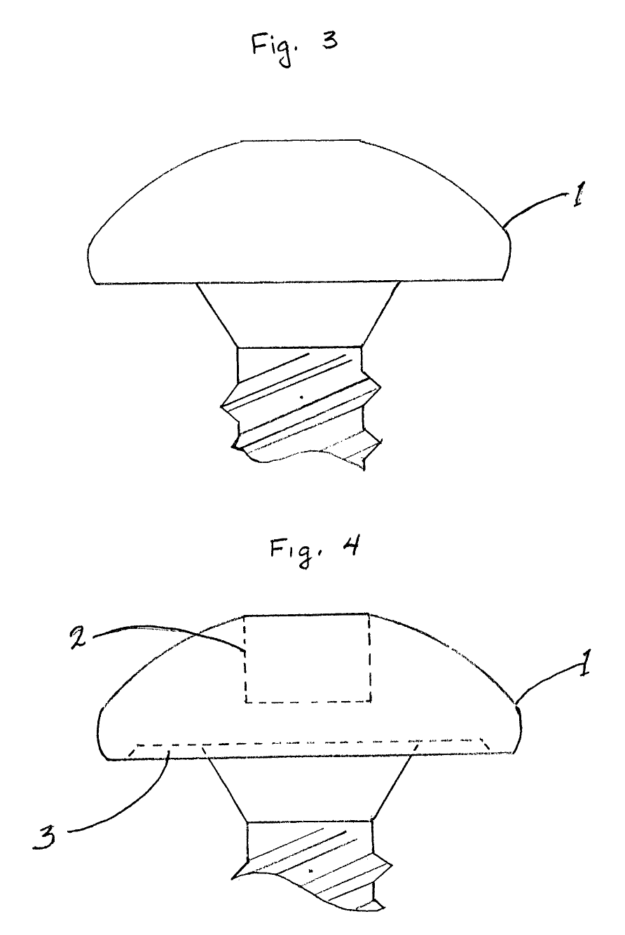

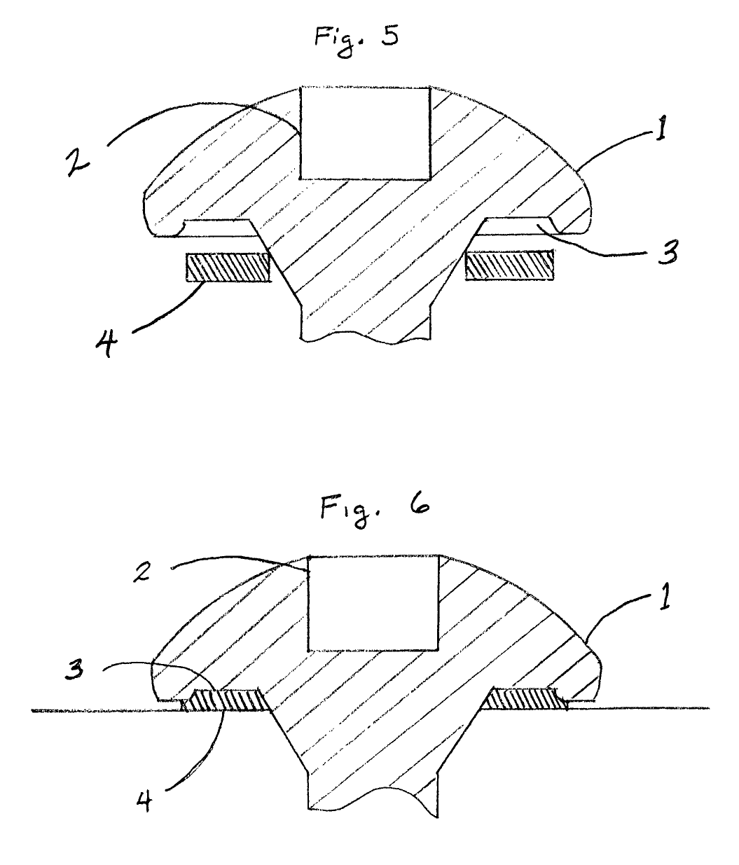

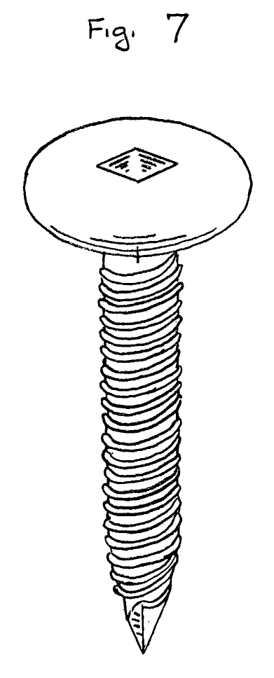

The preferred embodiment of this new design is illustrated in FIG. 1, Drawing #1 A perspective view of the dome headed roofing screw is illustrated in FIG. 7, Drawing #7 The concept of applying a domed head to a roofing screw is the essence of this patent, and the preferred application of it is illustrated herein The domed head, #1, in FIGS. 2, 4, 5+6, has a recessed slot, #2, for application of a square shaped driving tool. The domed head also has an indented seat, #3, shown in FIGS. 4, 5, +6, on the bottom side, intended for washer, #4, to seat in after application to roofing surface.

### OPERATION OF THE DEVICE

This screw design is intended to be used on a flat roofing surface. The screw, when fastened down properly, will be water tight to work properly as a fastener, and the domed head will offer little resistance to the downward movement of snow and ice off of a metal roof.

### SUMMARY, RAMIFICATIONS, AND SCOPE

The profile of the domed headed roofing screw design provided by my patent will offer roofing builders the opportunity of providing a much better finished product. Home owners will be less worried by snow and ice hanging up on their roofs, and their roofs will have less damage.

Also, home owners will be more confident that they will not have to shovel snow and ice off of their roof with these fasteners holding down their roofing.

I claim:

1. A dome headed roofing screw design which applies a domed screw head to a roofing screw. This screw has a square recessed slot in the domed head designed to receive a square driving tool. The under side of the domed head has an indented seat for a resilient washer to seat in while applied to the roofing surface.
